(19) United States
(12) Patent Application Publication
(10) Pub. No.: US 2010/0307231 A1
(43) Pub. Date: Dec. 9, 2010

(54) METHOD FOR DIAGNOSING THE BYPASS FLAP OF AN EXCHANGER IN AN EXHAUST GAS RECIRCULATION SYSTEM

(75) Inventors: Julien Allard, Savigny sur Orge (FR); Clement Petit, Paris (FR); Ronan Le Bras, Arpajon (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S, Boulogne Billancourt (FR)

(21) Appl. No.: 12/679,197

(22) PCT Filed: Sep. 19, 2008
(86) PCT No.: PCT/FR2008/051689

§ 371 Date: Jun. 28, 2010

(30) Foreign Application Priority Data
Sep. 20, 2007 (FR) 0757714

(51) Int. Cl. G01M 15/10

(52) U.S. Cl. 73/114.74

(57) ABSTRACT

A method for diagnosing a failure of an EGR circuit in an engine that includes an EGR exchanger, an EGR valve, an EGR exchanger bypass duct, and a bypass flap located upstream from the EGR exchanger and the bypass circuit in order to adjust the proportion of exhaust gases flowing therethrough. The EGR circuit can be activated in a cooled mode in which the flap is shut and in a bypass mode in which the flap is open. The method estimates the temperature of the exhaust gases at the outlet of the EGR exchanger when the EGR circuit is in the bypass mode.

### FIELD OF THE INVENTION

The present invention relates to a method of diagnosing a failure of the EGR circuit of an engine, more specifically the blocking of the bypass flap of the EGR exchanger.

### BACKGROUND OF THE INVENTION

The bypass flap is a key element in the exhaust gas recirculation (EGR) system.

Its function is to direct a desired quantity of EGR gases into a bypass circuit of the EGR exchanger in order to exploit the hot gases in priming the catalyst.

The correct operation of the flap therefore makes it possible to guarantee depollution of current diesel engines. The blocking of the flap in bypass mode or in cooled mode has direct consequences on the pollution emitted at the outlet of the engine.

Since the depollution thresholds are becoming increasingly strict, it is vitally important, in order to satisfy the next standards, to diagnose such failures of the flap.

The risk associated with blocking of the flap is also not linked solely to pollution. In practice, a failure of the flap can have consequences on the reliability of the surrounding components (degradation due to an excessively high temperature of the EGR valve and its mounting) and the integrity of the engine control strategies that use it (such as, for example, the clearing of the valve and of the exchanger, or even priming of the catalyst).

A number of methods for diagnosing failures have already been developed, with variable performance levels.

A first method, disclosed in the document JP2006-291921, uses a temperature sensor situated at the inlet of the intake distributor and makes it possible to diagnose a blocking of the flap by measuring the temperature difference between the cooled mode and the bypass mode. However, this method requires actuation of the flap to be able to carry out the diagnosis. Furthermore, it does not make it possible to detect the position in which the flap is blocked; now, blocking in bypass mode or in cooled mode does not have the same impact on pollution and a different reaction is desirable for the two cases. Moreover, this method appears relatively imprecise because the temperature sensor situated at the inlet of the intake distributor is subject to the influence of the cool air admitted.

Another method, disclosed in the document JP 2003-247459, implements a strategy based on monitoring the air flow rate before and after activation of the bypass flap, the air intake flap and the EGR valve being fully open. The benefit of this solution is that it simply uses the flow meter situated on the cool air intake duct. However, depending on the technical means employed, this strategy may lead to a not-inconsiderable false detection ratio, due to the EGR environment (high temperature, fouling of the connectors) and the limited reactivity of the control of the flap. In practice, pressure wave phenomena delay the control by partial vacuum of the bypass flap. Furthermore, it entails intervention into the operation of the engine, since it imposes opening the air intake flap and the EGR valve.

Finally, other applications use a contactor that makes it possible to know the open/closed position of the flap. However, this strategy can also lead to a high wrong detection ratio, because of the EGR environment.

One aim of the invention is therefore to define a simple and reliable, but non-intrusive, method that makes it possible to detect any failure of the bypass flap and, where appropriate, the position in which the latter is blocked. This method should also make it possible to diagnose a total loss of the cooling function.

### BRIEF DESCRIPTION OF THE INVENTION

A first subject of the invention is a method for diagnosing a failure of the EGR circuit of an engine comprising an EGR exchanger, an EGR valve, a bypass duct of the EGR exchanger, and a so-called bypass flap, arranged upstream of the EGR exchanger and of the bypass duct so as to control the proportion of exhaust gases passing through the latter, wherein the EGR circuit can be activated according to a so-called cooled mode, in which the flap is closed, and a so-called bypass mode, in which the flap is open, this method being characterized in that it comprises the following steps:
estimation of the temperature of the exhaust gases at the outlet of the EGR exchanger when the EGR circuit is in bypass mode,
measurement of the temperature of the exhaust gases at the outlet of the EGR exchanger,
calculation of the difference between said estimated temperature and said measured temperature,
comparison of said difference with a first or a second predetermined threshold so that:
   if the EGR circuit is in bypass mode and the difference is greater than the first threshold, then a blocking of the flap in cooled mode is detected,
   if the EGR circuit is in cooled mode and the difference is less than the second threshold, then a blocking of the flap in bypass mode is detected.

According to other features of the invention:
if the flap is blocked in bypass mode, the EGR valve is closed;
to estimate the temperature of the exhaust gases at the outlet of the exchanger when the EGR circuit is in bypass mode, three efficiencies are calculated, as a function of the flow rate of the exhaust gases, given by the following formulae:

$${ɛ}_{1} ( {Q}_{EGR} ) = \frac{Tint - Tavt}{Tco - Tavt}$$

$${ɛ}_{2} ( {Q}_{EGR} ) = \frac{TeEGR - Tavt}{Tint - Tavt}$$

$${ɛ}_{3} ( {Q}_{EGR} ) = \frac{TeEGR - TsEGR}{TeEGR - Tco}$$

in which:
Tint is the temperature of the exhaust gases at the inlet of the EGR circuit,
Tco is the temperature of the coolant of the EGR exchanger,
Tavt is the temperature of the exhaust gases upstream of the EGR circuit,
TeEGR is the temperature of the exhaust gases at the inlet of the EGR exchanger;
the estimated temperature of the exhaust gases at the outlet of the exchanger when the EGR circuit is in bypass mode is given by the formula:

TsEGRₑₛₜ_{_{—}}_{byp}=ε₃·Tco+(1−ε₃)·[Tavt·(1−ε₂)+ε₂·[ε₁·(Tco−Tavt)+Tavt]].

Another subject of the invention relates to a device for diagnosing a failure of the EGR circuit of an engine comprising an EGR exchanger, an EGR valve, a bypass duct of the EGR exchanger, and a so-called bypass flap, arranged upstream of the EGR exchanger and of the bypass duct in order to control the proportion of exhaust gases passing through the latter, wherein the EGR circuit can be activated according to a so-called cooled mode, in which the flap is closed, and a so-called bypass mode, in which the flap is open, characterized in that it comprises:
a means of estimating the temperature of the exhaust gases at the outlet of the EGR exchanger when the EGR circuit is in bypass mode,
a means of measuring the temperature of the exhaust gases at the outlet of the EGR exchanger,
a means of calculating the difference between said estimated temperature and said measured temperature, and
a means of comparing said difference with a first or a second predetermined threshold so that:
   if the EGR circuit is in bypass mode and the difference is greater than the first threshold, then the device detects a blocking of the flap in cooled mode,
   if the EGR circuit is in cooled mode and the difference is less than the second threshold, then the device detects a blocking of the flap in bypass mode.

According to another characteristic, the device according to the invention also comprises:
a means of measuring the temperature of the coolant of the EGR exchanger, and
a means of measuring the temperature of the exhaust gases upstream of the EGR circuit.

### BRIEF DESCRIPTION OF THE DRAWINGS

Other aims, features and benefits of the invention will become more apparent from reading the following detailed description of the invention, with reference to the appended figures in which:

FIG. 1 is a diagrammatic view of an engine compartment in which the method according to the invention is implemented,

FIG. 2 diagrammatically represents an EGR exchanger and its bypass duct,

FIG. 3 illustrates the theoretical breakdown of the EGR circuit into a plurality of individual exchangers,

FIG. 4 is a flow diagram of the diagnosis strategy,

FIG. 5 illustrates the case of a functional bypass flap,

FIG. 6 illustrates the case of a bypass flap blocked in cooled mode,

FIG. 7 illustrates the case of a bypass flap blocked in bypass mode.

### DETAILED DESCRIPTION OF THE INVENTION

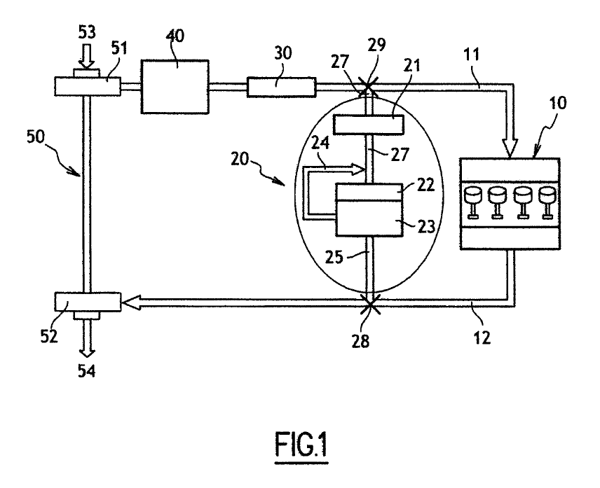

Referring to FIG. 1, an engine compartment comprises an internal combustion engine 10, supplied with cool air via an intake duct 11 and releasing its exhaust gases via an exhaust duct 12. Optionally, this engine compartment is also provided with a turbocharger 50 comprising a compressor 51 arranged on the intake duct to compress the air coming from the duct 53. If necessary, cooling means 40 and a flap 30 are provided between the compressor 51 and the engine 10. The air that reaches the engine 10 is therefore cold. The turbine 52 of the turbocharger 50 is situated at the end of the exhaust duct 12 and is coupled to the compressor 51. The exhaust gases are then discharged from the engine compartment via a duct 54.

The engine compartment also comprises an exhaust gas recirculation (EGR 20) circuit, the inlet 28 of which is connected to the exhaust duct 12 and the outlet 29 of which is connected to the intake duct 11. This EGR circuit 20 comprises a cooler or EGR exchanger 22, linked to the inlet 28 via an upstream duct 25 and to the outlet 29 via a downstream duct 27, making it possible to cool the exhaust gases before reinjecting them into the engine 10.

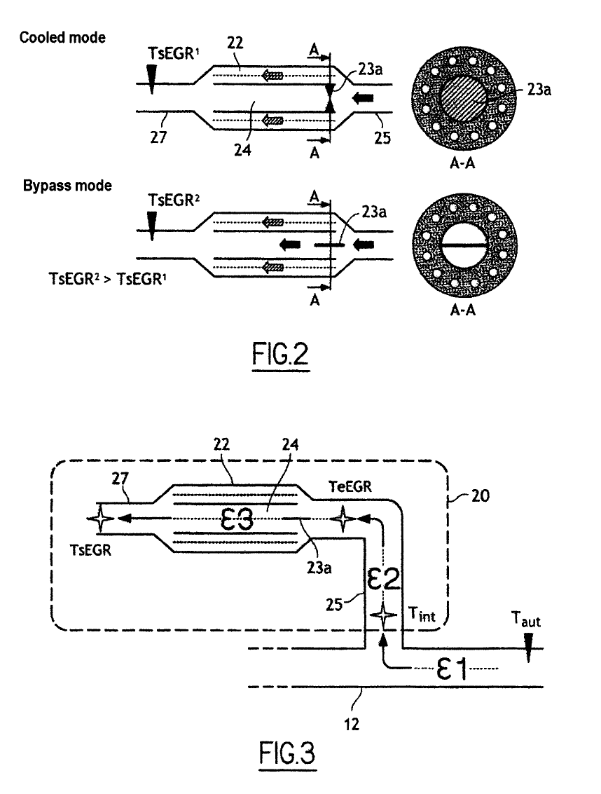

There is also provided a bypass duct 24 connected, in its upstream portion, to a solenoid valve 23 situated upstream of the EGR exchanger 22, and, in its downstream portion, to the outlet of the exchanger 22. The solenoid valve 23 comprises a flap 23a which, depending on its position, allows a desired quantity of exhaust gases to pass through the bypass duct 24. Thus, by controlling the position of the flap of the solenoid valve 23, predetermined quantities of gases are allowed to pass through the bypass duct 24 (where they will not be cooled) and into the EGR exchanger 22 (where they will be cooled). This makes it possible to adjust the temperature of the gases at the outlet of the exchanger 22. It should be specified that there are various technical definitions of the EGR exchanger and that the bypass circuit 24 can be separate from the exchanger 22 (as represented in FIG. 1), or incorporated in the latter (as will be seen in FIG. 2).

An EGR valve 21 is also provided at the outlet of the circuit 20 in order to control the quantity of exhaust gases reinjected into the engine 10.

FIG. 2 represents an EGR exchanger 22 with an incorporated bypass duct 24. If the flap 23a is closed, all the hot exhaust gases (solid arrow) pass through the EGR exchanger where they are cooled (shaded arrows): this is then called the “cooled mode”. If, however, the flap 23a is open, at least a portion of the exhaust gases pass through the bypass duct 24 and are not cooled: this is then called “bypass mode”. It will therefore be understood that the temperature TsEGR of the exhaust gases at the outlet of the exchanger 22 is higher in bypass mode (TsEGR2) than in cooled mode (TsEGR1).

According to the invention, the diagnosis strategy is based on measuring or estimating the temperature at the outlet of the EGR exchanger 22. This temperature can, depending on the case, be measured upstream or downstream of the EGR valve 21.

More specifically, the strategy is based on calculating the difference between the TsEGR estimated in bypass mode (denoted TsEGRₑₛₜ_{_{—}}_{byp}) and the measured TsEGR (denoted TsEGRₘₑₛ).

To this end, the Applicant has developed a model of the TsEGR in bypass mode that is the subject of the patent application FR 06 10065.

Three types of efficiencies are estimated as a function of the flow rate of the EGR gases.

The flow rate of the EGR gases (denoted Q_{EGR}) is in turn estimated as corresponding to the difference between the engine flow rate (denoted Q_{engine}) to within the filling flow rate (denoted η_{filling}) and the cool air flow rate (Qₐᵢᵣ)

Q_{EGR}=Q_{engine}(η_{filling})−Qₐᵢᵣ

The filling efficiency is determined by means of the temperature Tcol and the pressure Pcol in the intake manifold; these values are given by sensors situated in the intake manifold.

The abovementioned three efficiencies correspond to the breakdown of the EGR circuit 20 into three individual exchangers, represented in FIG. 3:
the first individual exchanger corresponds to the exhaust duct 12 (temperature Tavt), as far as the inlet 28 of the EGR circuit 20 (temperature Tint);
the second individual exchanger corresponds to the duct 25 between the inlet 28 of the EGR circuit 20 (temperature Tint) and the inlet of the EGR exchanger 22 (temperature TeEGR);
the third individual exchanger corresponds to the portion between the inlet of the EGR exchanger 22 (temperature TeEGR) and the outlet of the EGR exchanger 22 in bypass mode (temperature TsEGR).

This is reflected by the following three equations:

$${ɛ}_{1} ( {Q}_{EGR} ) = \frac{Tint - Tavt}{Tco - Tavt}$$

$${ɛ}_{2} ( {Q}_{EGR} ) = \frac{TeEGR - Tavt}{Tint - Tavt}$$

$${ɛ}_{3} ( {Q}_{EGR} ) = \frac{TeEGR - TsEGR}{TeEGR - Tco}$$

in which:
Tint is the temperature of the exhaust gases at the inlet of the EGR circuit (20),
Tco is the temperature of the coolant of the EGR exchanger (22),
Tavt is the temperature of the exhaust gases upstream of the EGR circuit (20),
TeEGR is the temperature of the exhaust gases at the inlet of the EGR exchanger (22).

The estimated temperature TsEGR in bypass mode is deduced therefrom:

TsEGRₑₛₜ_{_{—}}_{byp}=ε₃·Tco+(1−ε₃)·[Tavt·(1−ε₂)+ε₂[ε₁·(Tco−Tavt)+Tavt]]

The estimation of the temperature TsEGR in bypass mode therefore requires the presence of three temperature sensors: Tco, Tavt, Tcol and a pressure sensor Pcol.

Having the temperature TsEGRₘₑₛ measured by a probe situated at the outlet of the EGR exchanger 22, and the temperature TsEGR estimated in bypass mode according to the formula explained hereinabove, it is possible to continuously diagnose the functionality of the bypass flap 23a, both in bypass mode and in cooled mode, and do so without controlling it (that is to say without intervention in the operation of the flap). It is in effect considered that, if the flap 23a is functional, then:
if the flap is controlled in bypass mode, the difference between TsEGRₑₛₜ_{_{—}}_{byp} and TSEGRₘₑₛ must be low;
if the flap is controlled in cooled mode, the difference between TsEGRₑₛₜ_{_{—}}_{byp} and TSEGRₘₑₛ must be high.

A threshold S_{bm} and a threshold S_{cm} are therefore defined, by statistical studies, so that:
if the difference |TsEGRₑₛₜ_{_{—}}_{byp}−TSEGRₘₑₛ| is greater than S_{bm} when the flap is controlled in bypass mode, it is considered that the flap is blocked in cooled mode;
if the difference |TsEGRₑₛₜ_{_{—}}_{byp}−TsEGRₘₑₛ| is less than S_{cm} when the flap is controlled in cooled mode, it is considered that the flap is blocked in bypass mode.

The causes of blocking of the flap 23a may be a mechanical seizure, disconnection of the hose from the bypass solenoid valve 23 or even a control problem.

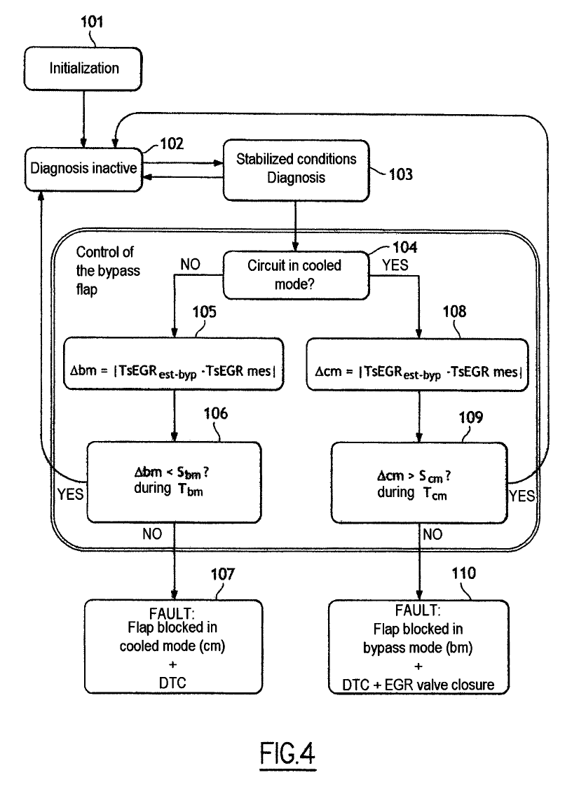

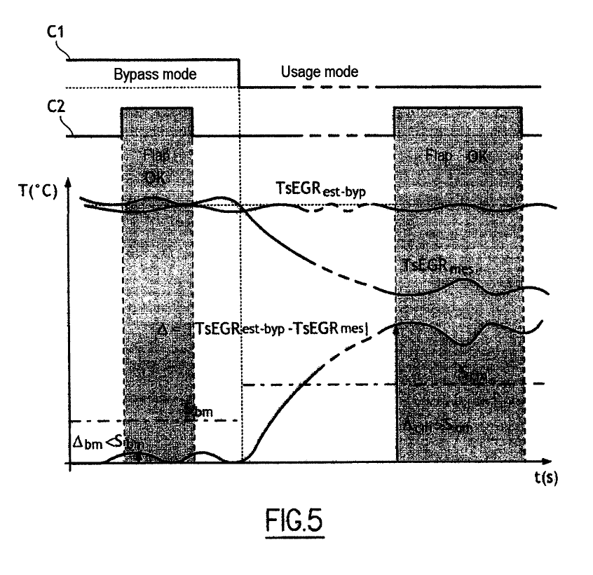

The flow diagram of FIG. 4 more precisely illustrates the logical diagnosis procedure:
when the vehicle is started, the device is initialized (box 101);
until the conditions have stabilized (box 102), the diagnosis is inactive; in practice, to increase detection reliability, the diagnosis is carried out on operating points where the speed and torque are stable, dispensing with the transient modes that generate widely dispersed estimations of TsEGR and Q_{EGR};
when the conditions are stabilized (box 103), the activation mode of the EGR circuit is detected: bypass mode or cooled mode (box 104);
if the EGR circuit is in bypass mode:
   the temperature TsEGR is measured and the temperature TsEGR estimated in bypass mode is calculated, then the temperature difference is calculated:

Δbm=|TsEGRₑₛₜ_{_{—}}_{byp}−TsEGRₘₑₛ| (box 105);
the temperature difference Δbm is compared with the previously determined threshold S_{bm} (box 106),
if Δbm is less than the threshold S_{bm}, the flap is considered to be functional and the diagnosis is deactivated (box 102),
if Δbm is less than the threshold S_{bm}, a failure is detected, attributed to the blocking of the flap in cooled mode (box 107);
if the EGR circuit is in cooled mode:
   the temperature TsEGR is measured and the temperature TsEGR estimated in bypass mode is calculated, then the temperature difference is calculated:

Δcm=|TsEGRₑₛₜ_{_{—}}_{byp}−TsEGRₘₑₛ| (box 108);
the temperature difference Δcm is compared with the previously determined threshold S_{cm} (box 106),
   if Δcm is greater than the threshold S_{cm}, the flap is considered to be functional and the diagnosis is deactivated (box 102),
if Δcm is less than the threshold S_{cm}, a failure is detected, attributed to the blocking of the flap in bypass mode (box 110).

When the fault is confirmed, an information item (called DTC or “Diagnostic Trouble Code”) is stored in the manufacturer memory; a service indicator (called OBD or On Board Diagnostic) lights if the emissions exceed the stipulated thresholds.

Finally, if the flap is blocked in bypass mode (box 110), a degraded mode is activated, consisting in closing the EGR valve 21 in order to reduce the temperature at its terminals.

This strategy is implemented in the engine control unit (ECU).

FIG. 5 illustrates the case of a functional flap.

The curve C1, in the form of a pulse, corresponds to the control state of the bypass flap: the high value corresponds to the bypass mode, the low value corresponds to the cooled mode.

The curve C2, in the form of a pulse, corresponds to the diagnosis condition: the high values correspond to the diagnosis phases.

In this figure, it can be seen that, during the first phase, the EGR circuit is in bypass mode and the temperature difference Δbm is less than the detection threshold in bypass mode S_{bm}: the flap is therefore considered to be functional. Similarly, during the second diagnosis phase, the EGR circuit is in cooled mode, and the temperature difference Δcm is greater than the detection threshold in cooled mode S_{cm}: the flap is therefore detected as being functional.

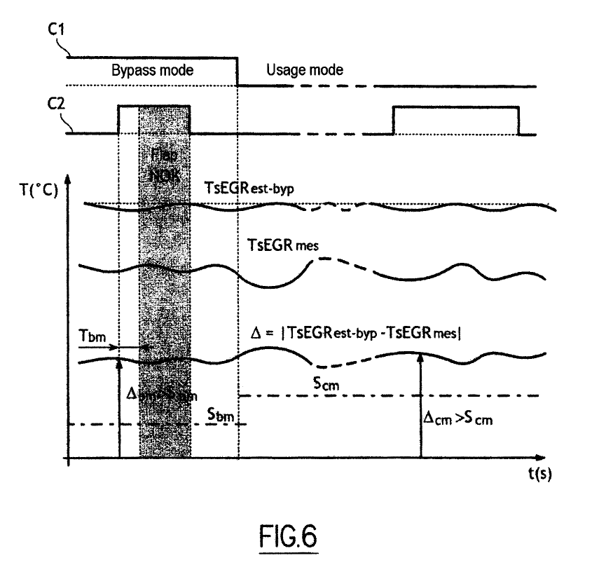

Referring to FIG. 6, let us look at the case of a flap blocked in cooled mode.

The curves C1 and C2 are defined in the same way as in FIG. 5.

During the first diagnosis phase, the EGR circuit is in bypass mode. Now, the temperature difference Δbm remains greater than the detection threshold in bypass mode S_{bm} for a duration Tbm: the flap is therefore considered to be blocked in cooled mode.

Assuming that the first diagnosis phase was run while the EGR circuit was in cooled mode (see second pulse of the curve C2), the flap would have been judged to be functional (since Δcm is greater than S_{cm}), but it would have been detected as failed in bypass mode during the next diagnosis cycle.

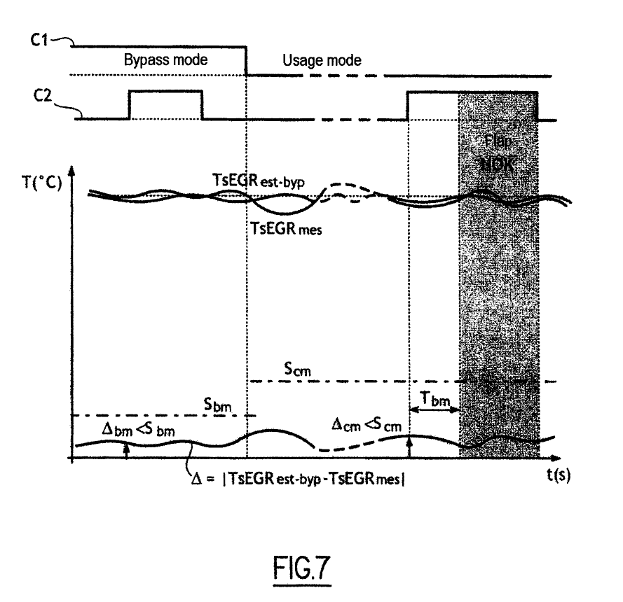

Referring to FIG. 7, let us now look at the case of a flap blocked in bypass mode.

The curves C1 and C2 are defined in the same way as in FIGS. 5 and 6.

During the first diagnosis phase, the EGR circuit is in bypass mode. Since the temperature difference Δbm is less than S_{bm}, the flap is therefore considered to be functional.

The next diagnosis phase, in cooled mode, makes it possible to reveal the failure of the flap. In practice, the temperature difference Δcm remains less than S_{bm} for a duration Tcm: it is deduced therefrom that the flap is blocked in bypass mode.

Compared to other technical solutions that use a flow meter or a contactor, the use for the diagnosis of a temperature sensor at the outlet of the EGR exchanger (measuring TₛEGRₘₑₛ) enhances the detection reliability of the method. Furthermore, this temperature sensor can advantageously be used, depending on requirements, for other diagnoses. Thus, the method according to the invention makes it possible to detect a total loss of the cooling function; failures leading to this loss—for example a water leak—however being more rare.

Compared to other known methods, the inventive method further offers the benefit of not being intrusive, that is to say that it does not require the bypass flap to be actuated in order to check its functionality. Implementing this method does not therefore result in any additional pollution.

Finally, the present strategy makes it possible to know the position in which the bypass flap is blocked: this information is necessary to the judicious actuation of the degraded mode (i.e. only if the flap is blocked in bypass mode), which represents an additional gain in terms of depollution.

1-6. (canceled)

7. A method for diagnosing a failure of an EGR circuit of an engine including an EGR exchanger, an EGR valve, a bypass duct of the EGR exchanger, and a bypass flap, arranged upstream of the EGR exchanger and of the bypass duct so as to control a proportion of exhaust gases passing through the bypass duct, wherein the EGR circuit can be activated according to a cooled mode, in which the flap is closed, and a bypass mode, in which the flap is open, the method comprising:
estimating a temperature of the exhaust gases at an outlet of the EGR exchanger when the EGR circuit is in the bypass mode;
measuring the temperature of the exhaust gases at the outlet of the EGR exchanger;
calculating the difference between the estimated temperature and the measured temperature;
comparing the difference with a first or a second predetermined threshold so that:
if the EGR circuit is in the bypass mode and the difference is greater than the first threshold, then a blocking of the flap in the cooled mode is detected,
if the EGR circuit is in the cooled mode and the difference is less than the second threshold, then a blocking of the flap in the bypass mode is detected.

8. The method as claimed in claim 7, wherein if the flap is blocked in the bypass mode, the EGR valve is closed.

9. The method as claimed in claim 7, wherein, to estimate the temperature of the exhaust gases at the outlet of the exchanger when the EGR circuit is in the bypass mode, three efficiencies are calculated, as a function of flow rate of the exhaust gases, given by following formulae:
$${ɛ}_{1} ( {Q}_{EGR} ) = \frac{Tint - Tavt}{Tco - Tavt}$$
$${ɛ}_{2} ( {Q}_{EGR} ) = \frac{TeEGR - Tavt}{Tint - Tavt}$$
$${ɛ}_{3} ( {Q}_{EGR} ) = \frac{TeEGR - TsEGR}{TeEGR - Tco}$$
in which:
Tint is the temperature of the exhaust gases at an inlet of the EGR circuit,
Tco is the temperature of a coolant of the EGR exchanger,
Tavt is the temperature of the exhaust gases upstream of the EGR circuit, and
TeEGR is the temperature of the exhaust gases at an inlet of the EGR exchanger.

10. The method as claimed in claim 9, wherein the estimated temperature (TsEGRₑₛₜ_{_{—}}_{byp}) of the exhaust gases at the outlet of the exchanger when the EGR circuit is in the bypass mode is given by:
TsEGRₑₛₜ_{_{—}}_{byp}=ε₃·Tco+(1−ε₃)·[Tavt·(1−ε₂)+ε₂·[ε₁·(Tco−Tavt)+Tavt]]

11. A device for diagnosing a failure of an EGR circuit of an engine including an EGR exchanger, an EGR valve, a bypass duct of the EGR exchanger, and a bypass flap, arranged upstream of the EGR exchanger and of the bypass duct to control a proportion of exhaust gases passing through the bypass duct, wherein the EGR circuit can be activated according to a cooled mode, in which the flap is closed, and a bypass mode, in which the flap is open, the device comprising:
means for estimating a temperature of the exhaust gases at an outlet of the EGR exchanger when the EGR circuit is in the bypass mode;
means for measuring the temperature of the exhaust gases at the outlet of the EGR exchanger;
means for calculating the difference between the estimated temperature and the measured temperature; and
means for comparing the difference with a first or a second predetermined threshold so that:
if the EGR circuit is in the bypass mode and the difference is greater than the first threshold, then the device detects a blocking of the flap in the cooled mode,
if the EGR circuit is in the cooled mode and the difference is less than the second threshold, then the device detects a blocking of the flap in the bypass mode.

12. The device as claimed in claim 11, further comprising:
means for measuring the temperature of a coolant of the EGR exchanger; and
means for measuring the temperature of the exhaust gases upstream of the EGR circuit.
